(19) United States
(12) Patent Application Publication
(10) Pub. No.: US 2012/0124872 A1
(43) Pub. Date: May 24, 2012

(54) ADVERTISEMENT DISPLAY DEVICE

(76) Inventor: Myung Sang Lim, Gyeongnam (KR)

(21) Appl. No.: 13/387,420

(22) PCT Filed: Jul. 26, 2010
(86) PCT No.: PCT/KR2010/004899

§ 371 Date: Jan. 27, 2012

(30) Foreign Application Priority Data
Jul. 28, 2009 (KR) 10-2009-0068982
Jul. 28, 2009 (KR) 10-2009-0068997

(51) Int. Cl. G09F 11/00

(52) U.S. Cl. 40/492

(57) ABSTRACT

Provided is an advertising display device displaying various figures by rotating a plurality of slits having four different figure portions on the front/back sides.

The advertising display device according to the present invention includes a plurality of separate slits 110 having a display part 111 displayed with many different kinds of figures or patterns, a support member 120 supporting the weight of the slits, a connecting member 130 connecting the slits with the support member, and an operation unit 140 forcing the slits to rotate and move.

### CROSS-REFERENCE TO RELATED APPLICATIONS

The present application claims priority to Korean Patent Application 10-2009-0068982 (filed on Jul. 28, 2009), Korean Patent Application 10-2009-0068997 (filed on Jul. 28, 2009), and PCT Patent Application No. PCT/KR2010/004899 (filed on Jul. 26, 2010), all of which are hereby incorporated by reference in its entirety.

### BACKGROUND OF THE INVENTION

1. Field of the Invention

The present invention relates to an advertising display device capable of selectively displaying various figures by rotating a plurality of slits having four different figure portions on the front/back sides, and maximizing display effect by making available separate on/off switches by applying LumiSheet as slit.

2. Description of the Related Art

Generally, various advertising display devices for visual advertisement are used, and a signpost, one of such display devices, is widely used.

The display device is fixed to the outer part of the building and phrases or patterns for advertisement are printed and displayed on the outer surface of the display device. Further, the inner part is constructed to include an emitting body to increase visibility at night for selective emanating.

However, such a display device has a print surface displaying only one shape and figure in manufacturing, lowering display effect.

Also, because it is arranged that replacing such print surface with another one is done by completely ripping off the print surface and attaching a newly-built print surface, decreasing installation and incurring exchange cost economically unacceptable.

### SUMMARY OF THE INVENTION

In order to solve the problems, an object of the present invention is to provide an advertising display device capable of selectively displaying various figures by rotating a plurality of slits having four different figure portions on the front/back sides, and maximizing display effect by making available separate on/off switches by applying LumiSheet as slit.

Another object of the present invention is to provide an advertising display device having more convenience in use by changing figures by easily transiting front/back surface positions with slits fixed to sidewall or ceiling.

In order to achieve the objects, an advertising display device according to the present invention includes: a plurality of slits having separate display parts that display many different kinds of figures or patterns; a support member supporting the weight of the slits; a connecting member connecting the slits with the support member; and an operation unit forcing the slits to rotate and move, in which the display parts are separated about a rotation center of each of the slits.

A guide block with a guide groove recessed straight is disposed under the slits and wheels that roll along the guide groove are disposed at one side of the lower end of each of the slits.

The display parts are separated about a center of each of the slits.

The slits partially and selectively overlap adjacent slits.

The display part is provided more than 4 on the outer surface of the slits.

An advertising display device includes: a plurality of slits having separate display parts that display many different kinds of figures or patterns; a support member supporting the weight of the slits and guiding movement of the slits; a connecting member connecting the slits with the support member; and an operation unit forcing the slits to rotate and move, in which a turning mechanism turning both sides of the slits by moving the connecting member is provided at a side of the support member.

The turning mechanism includes a guide rail guiding a moving direction of the connection body and selectively placing the connecting member in a width direction to the front and rear half portions of the support member, and a rotary bar disposed through the connecting member at a side in the guide rail and rotating the slit by selectively rotating.

The rotary bar has a curved portion formed by bending a portion of the rotary bar, and a pair of parallel portions, except for the curved portion, is parallel to each other.

The curved portion and the parallel portions have different cross-sectional shapes.

The parallel portions are rotatably constructed and the curved portion has a smaller cross-section than the parallel portions.

A moving wire disposed through the connecting member and forcing the connecting member to move while circulating into/out of support member by the operation of a user is provided at one side of the operation unit.

An anti-separation member preventing a moving wire in the connecting member, which passes the curved portion, from being separated is provided at position spaced from the rotary bar.

A receiving groove guiding rolling of the connecting member is recessed to have a curvature corresponding to the curved part is disposed at a side of the anti-separation body.

An anti-separation protrusion restricting movement in one direction of the moving wire by coming in contact with one side of the connecting member is provided at one side of the anti-separation body.

According to another embodiment of the present invention, an advertising display device includes a plurality of slits to block incident light by a selective rotating, in which the outer surfaces of the slits each having a display part includes: a first display part disposed on a side of the slit; a second display part separately disposed on the same surface with the first display part; a third display part disposed on the other side of the slit; and a fourth display part separately disposed on the same surface with the third display part.

The first display part to the fourth display part display different figures or patterns.

The first display part to the fourth display part have the same width.

The first display part to the fourth display part are provided in the slits, except for a pair of slits at both ends.

As specifically described above, the advertising display device according to the present invention is constructed to display various figures selectively by rotating a plurality of slits having four different figure portions on front/back surfaces.

Thus, indoor interior effect is maximized, improving product satisfaction.

Also, one embodiment of the present invention is constructed to make available separate on/off switches by applying LumiSheet as slit.

Thus, advertise display effect as well as indoor interior may be maximized.

Another object of the present invention is constructed to change front/back positions by a simple operation while slits are hung from the ceiling.

Therefore, as a good point, convenience of use is improved.

### BRIEF DESCRIPTION OF THE DRAWINGS

FIG. 1 is an upper-part perspective view showing the outlook of the advertising display device according to the present invention;

FIG. 2 is a plan view schematically showing the outlooks of slits that are components of the advertising display device according to the present invention;

FIG. 3 is a plan view schematically showing when the slits that are components of the advertising display device according to the present invention, are rotated;

FIG. 4 is a perspective view showing a turning mechanism that is an essential component of the advertising display device according to the present invention;

FIG. 5 is a plan view showing a anti-separation member that is an essential component of the advertising display device according to the present invention;

FIG. 6 is a vertical cross-sectional view taken along the line I-I′ of FIG. 1;

FIG. 7 is a vertical cross-sectional view taken along the line II-II′ of FIG. 1;

FIG. 8 is a perspective view of combination state of a driving unit that is a component of the advertising display device according to the present invention;

FIG. 9 is a front view showing the configuration of a connecting member that is an essential component of the advertising display device according to the present invention; and

FIG. 10 is a schematic view showing a lower fixing structure of slits that are essential components of the advertising display device according to the present invention.

### DETAILED DESCRIPTION OF THE INVENTION

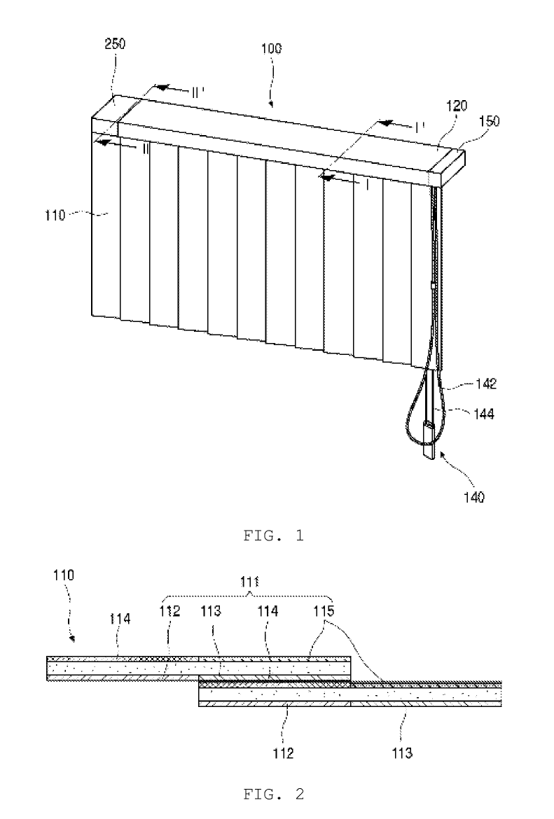

Hereinafter, an advertising display device of the present invention will be explained by reference to the accompanying FIGS. 1 through 3.

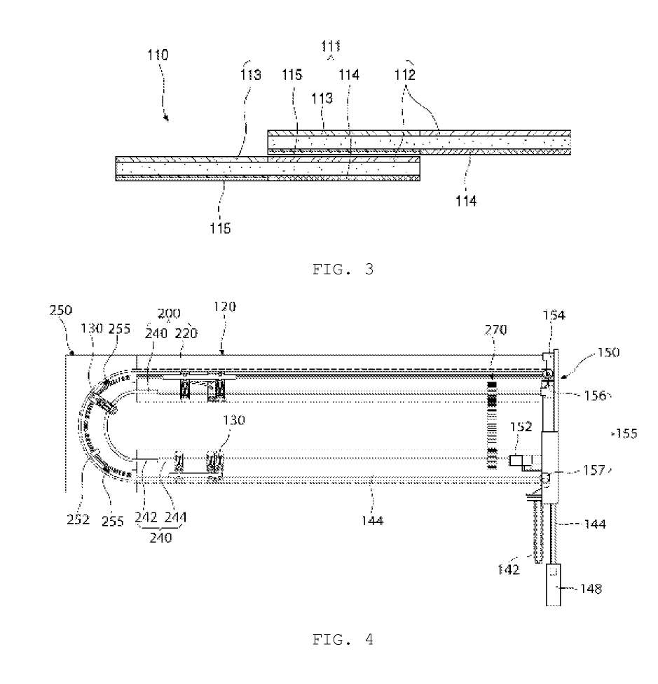

FIG. 1 is an upper-part perspective view showing the outlook of the advertising display device according to the present invention; FIG. 2 is a plan view schematically showing the outlooks of slits, that are components of the advertising display device according to the present invention; FIG. 3 is a plan view schematically showing when of the slits, components of the advertising display device according to the present invention, is rotated.

As shown in the drawings, an advertising display device 100 includes a plurality of separate slits 110 each having a display part 111 displaying many different kinds of figures or patterns, a support member 120 supporting the weight of the slits 110, a connecting members (see reference numeral 130 of FIG. 4) connecting the slits 110 with the support member 120, and an operation unit 140 forcing the rotation and movement of the slits 110.

The slit 110 shows four different figures or patterns while being selectively rotated by the operation of the operation unit 140, and the display parts 111 of the slits 110 are separated about the rotation center of each of the slits 100 for display.

The slits 110 selectively and partially overlap adjacent slits 110.

In the following, the detailed configuration of the slits 110 will be inspected with reference to the accompanying FIGS. 2 and 3.

As shown in the drawings, the slits 110 according to an embodiment of the present invention are regularly arranged to partially overlap each other, and the rotation center of the slit 110 is on the same line as one end of an adjacent slit 110.

That is, the slits 110, as shown in FIG. 2, are arranged such that the left portion of the top (the back side, in FIG. 1) of the lower (front, in FIG. 1) slit 110 covers and overlaps the right portion of the bottom (the front side, in FIG. 1) of the upper (rear, in FIG. 1) slit 110.

Thus, when the slits 110 are arranged, as shown in FIG. 2, only the lower surface (front surface in FIG. 1) of each slit 110 is exposed to the outside and displays figures or patterns.

In detail, the display part 111 includes a first display part 112 partially disposed on one side of the slit 110, a second display part 113 separately disposed on the same surface as the first display part 112, a third display part 114 partially disposed on the other side of the slit 110, and a fourth display part 115 separately disposed on the same surface as the third display part 114, and the first display part 112 to the fourth display part 115 have the same width.

Thus, in FIG. 2, the first display part 112 and the second display part 113 are positioned on the front sides of the slits 110, and the third display part 114 and the fourth display part 115 are positioned on the back sides of the slits 110.

Further, the same figure is cut and attached to the first display part 112 to the fourth display part 114 of the slits 110.

That is, in FIG. 2, the first display parts 112 are exposed at the front left portions of two slits 110 exposed to the front and the two first display parts 112 make a portion of a figure.

Thus, when all the slits 110 rotate in the direction of an arrow in FIG. 2, the first display parts 112 are positioned at the rear right portions, as in FIG. 3, and the fourth display parts 115 positioned at the back side in FIG. 2 are positioned at the front right portions, as in FIG. 3, so that a user can see the fourth display parts 115.

On the other hand, slits 110 at the left and right ends have a smaller width than those of the other slits 110 disposed there between, not showing a figure or a pattern.

That is, the leftmost and rightmost slits 110 are not provided with a display part 111. This is because a figure is completed only when the slits 110 overlap the halves of the adjacent slits 110, regardless of that any surface of the slits 110 turns to the front side.

Meanwhile, the operation unit 140 is disposed at the left lower portion of the advertising display device 100, at a predetermined position, as shown in FIG. 1.

The operation unit 140 includes a rotating wire 142 for rotating the slits 110 and a moving wire 144 for moving the slits 110.

The rotating wire 142 makes a closed loop, through a wire support member (reference numeral 150 in FIG. 4), which is described below.

The moving wire 144 is partially suspended under the support member 120, and the other portions passes through the wire support member 150 and the connecting members 130.

The combination of the rotating wire 142 and the moving wire 144 will be described below.

On the one hand, an anti-separation member 250 is disposed at the left end of the support member 120. The anti-separation member 250 allows the connecting members 130, which move left in the support member 120, to turn right while supporting the connecting members 130 upward to prevent separation.

Thus, the connecting members 130 turn through the anti-separation member 250, and in this process, the slits 110 change the position of the front side and back side, so that a user can see the figure and pattern on the back sides, from the front.

Further, a turning mechanism 200 that guides the movement of the connecting members 130 together with the anti-separation member 250 is disposed in the support member 120.

This turning mechanism 200, which is an essential component of the present invention, moves the slits 110 to the left to turn around at the rear side, from the position shown in FIG. 1.

The following description is provided with reference to FIGS. 4 to 7.

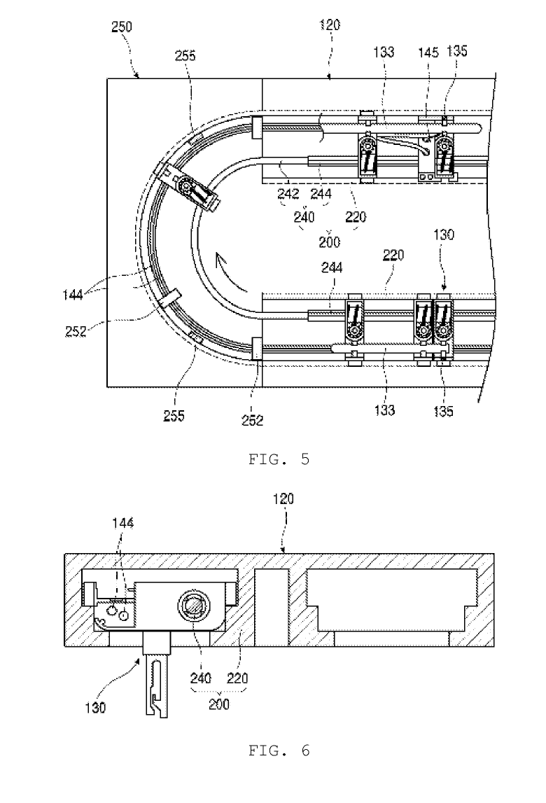

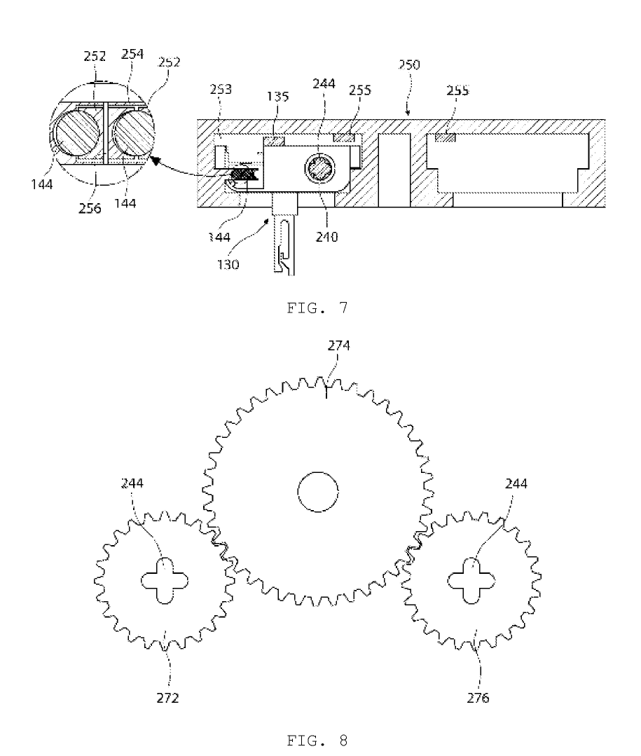

FIG. 4 is a perspective view showing a turning mechanism 200 that is an essential component of the advertising display device according to the present invention, FIG. 5 is a plan view showing a anti-separation member that is an essential component of the advertising display device according to the present invention, FIG. 6 is a vertical cross-sectional view taken along the line I-I′ of FIG. 1, and FIG. 7 is a vertical cross-sectional view taken along the line II-II′ of FIG. 1.

First, as shown in FIG. 6, the turning mechanism 200 includes a guide rail 220 guiding movement of the connecting member 130 and selectively positioning the connecting members 130 at the front/rear half portions in a width direction of the support member 120, and a rotary bar 240 disposed through the connecting member 130 at a side in the guide rail 220 and rotating the slits 110 by selectively rotating.

The guide rail 220 is stepped such that the horizontal size of the lower opening is smaller than the horizontal size of the inside and supports the left/right lower portions of the connecting members 130 upward to move the connecting members 130.

This guide rail 220 is symmetrically formed in the inner left/right sides inside the support member 120.

That is, it is desirable that the guide rail 220 is symmetrically formed in the inner left/right sides in support member 120 as seen in FIG. 6, because the guide rail 220, as can be seen from FIG. 4, is necessary to prevent the connecting members 130, which move along the rotary bar 240, from separating, at regular intervals from the rotary bar 240.

Meanwhile, the guide rail 220 is formed as long as a certain size. That is, the length of the guide rail 220 corresponds to the parallel portions of the rotary bar 240 shown in FIG. 5, and the guide rail 220 is not formed at the left side, which is the curved portion, of the rotary bar 240.

In detail, as shown in FIG. 5, the anti-separation member 250 is connected to the end of the guide rail 220 and guides the connecting member 130 coming out from the guide rail 220 to make a U turn.

The anti-separation member 250 prevents the moving wire 144 inside the connecting member 130 passing the curved portion of the rotary bar 240 from separating, and a plurality of anti-separation rollers 252 and roller supports 254 are disposed radially at regular intervals in the anti-separation member 250.

The anti-separation roller 252 are disposed at the left and right sides at a predetermined distance inside a pair of roller supports 254, as shown in FIG. 7, and fitted on a rotary shaft 256 to be rotated. Each of anti-separation rollers 252 guides one moving wire 144 to the left.

Thus, the anti-separation roller 252 rotates while supporting the moving wire 144 to prevent the moving wire 144 from loosening, and the roller support 254 and anti-separation roller 252 are inserted in an opening 139, which is described below, thereby preventing separation of the moving wire 144.

Hereafter, the detailed configuration of the rotary bar 240 will be described with reference to FIG. 4.

The rotary bar 240 has parallel front and rear half portions and the left side is bent substantially in a “⊂” shape.

That is, the rotary bar 240 has a curved portion 242 roundly bent and a pair of parallel portions 244 connected to both ends of the curved portion 242, in parallel with each other.

Although not shown, the curved portion 242 and the parallel portion 244 have a wire therein.

The wire is disposed through both the curved portion 242 and the parallel portion 244 to allow the parallel portions 244 to rotate.

Since the curved portion 242 is bent, rotation is prevented even though the wire is inserted therein.

The parallel portions 244 and the curved portion 242 have different cross-sectional shapes.

That is, the parallel portion 244 has a substantially +-shaped vertical cross-section and the curved portion 242 has a circular vertical cross-section.

The outer diameter of the curved portion 242 is smaller than the outer size of the parallel portion 244.

Therefore, the connecting member 130 can smoothly move along the parallel portions 244 and the curved portion 242.

The pair of parallel portions 244 is provided with a driving unit 270. The driving unit 270 forces the pair of parallel portions 244 to simultaneously rotate and rotates the pair of parallel portions 244 in opposite directions, using a force transmitted when the rotating wire 142 is operated.

The detailed configuration of the driving unit 270 will be described hereafter with reference to FIG. 8.

FIG. 8 is a perspective view of the combination state of a driving unit 270 that is a component of the advertising display device according to the present invention.

In the drawings, the driving unit 270 rotates the other parallel portion 244 in the opposite direction, using the force transmitted to any of the pair of parallel portions 244.

For this configuration, the driving unit 270 includes a driving gear 272 receiving a force from the rotating wire 142, a driven gear 276 spaced apart from the driving gear 272 and simultaneously rotating, and a transmission gear 274 transmitting a rotation force of the driving gear 272 to the driven gear 276.

The driving gear 272 and the driven gear 276 have the same shape such that the pair of parallel portion 244 can simultaneously rotate, and the transmission gear 274 is disposed between the driving gear 272 and the driven gear 276 to be engaged with the gears such that the driving gear 272 and the driven gear 276 can simultaneously rotate.

The transmission gear 274 maintains a predetermined position inside the support member 120 in order not to separate. That is, the transmission gear 274 has a separate holder (not shown) and is rotatably fixed to the holder and it is preferable that the holder is fixed to the inner ceiling in the support member 120.

Thus, the rotation force of the driving gear 272 is transmitted to the driven gear 276 through the transmission gear 274 and the pair of parallel portions 244 can simultaneously rotate in the same direction.

The support member 150 is disposed at the right side of the driving unit 270, as shown in FIG. 4. The wire support member 150 is coupled to the right end of the support member 120 to support the rotating wire 142 and the moving wire 144 while supporting the rotary bar 240.

For this configuration, the external appearance of wire support member 150 is formed by a body 152 and the body 152 has a bar coupling portion 154 where both ends of the rotary bar 240 are coupled, a carrying roller 155 guiding the moving wire 144 to form a closed loop, and a rotary gear (not shown) disposed at a side in the body 152 and selectively holding the rotating wire 142, which is pulled, to rotate the bar coupling portion 152.

The body 152 has a length corresponding to the width of the support member 120 and coupled to right end of the support member 120 to form a portion of the external appearance of the advertising display device 100.

The bar coupling portion 152 is rotatably coupled to the body 152 and has a bearing (not shown).

The bar coupling portions 154 are coupled to the pair of parallel portions 244, respectively, to rotate the pair of parallel parts 244.

Also, the rotating gear is coupled only to any one of the pair of the bar coupling portions 154 to simultaneously rotate the pair of parallel portions 244 through the driving unit 270.

A plurality of carrying rollers 155 is disposed in the body. The carrying rollers 155 guide the moving wire 144 forming a closed loop to move along the same path, and include a reverse roller 156 returning the moved moving wire 144 to the initial position and a guide roller 157 forming the closed loop of the moving wire downward inside the support member 120.

The guide rollers 157 are provided in a pair to guide downward the moving wire 144 moving parallel to the rotary bar 240 and the reverse roller 156 is a single unit.

Thus, the moving wire 144 passes any one of the pair of guide rollers 157 through weight, is guided along the other of the pair of guide rollers 157 after passing the reverse roller 156 and then guided back to the weight, thereby forming a closed loop.

Also, the moving wire 144 forms a closed loop, and both the cut ends are bound to a coupler 145 of FIG. 5.

Thus, according to the direction in which a tension applied to the ends of the moving wire 144 bound to the coupler 145, the connecting member 130 is forced to move to the left/right sides.

Obviously, the connecting members 130 and the coupler 145 are connected by a connector 133 having a predetermined length, and not spaced apart from each other more than a certain interval; thus when the coupler 145 moves, all the connecting members 130 move in the same direction.

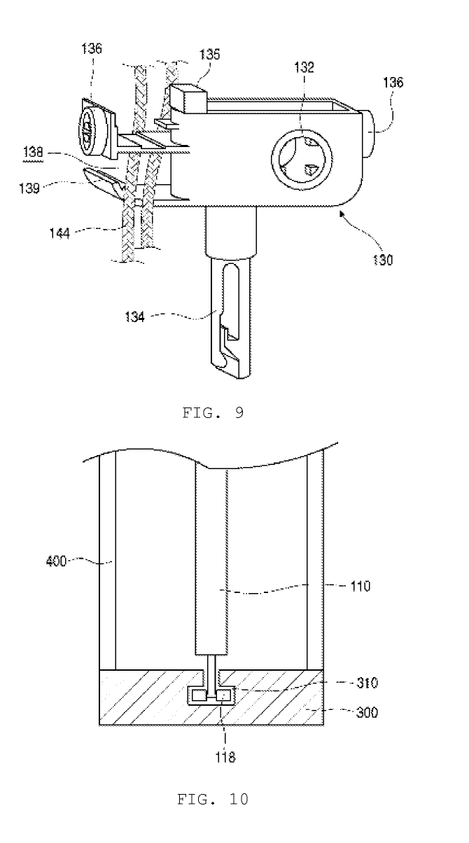

The configuration of the connecting member 130 will be described in detail with reference to FIG. 9.

FIG. 9 is a front view showing the configuration of a connecting member 130 that is a component of the advertising display device according to the present invention.

The connecting member 130 supports the slit 110 as described above, and moves along the rotary bar 240 inside the support member 120, such that the slits 110 are selectively collected.

For this configuration, the connecting member 130 includes an insertion portion 132 bored in a shape similar to the cross-section of the parallel portion 244 to insert the parallel portion 244, a clip 134 coupled with the slit 110, rolling portions 136 rotating at the left and right sides of the connecting member 130 to allow the connecting member 130 to roll along the guide rail 220, a receiving portion 138 receiving the moving wire 144, and a gear portion (not shown) transmitting a rotation force that the insertion portion 132 receives from the parallel portion 244, to the clip 134.

The insertion portion 132 is coupled to pass the parallel portion 244 such that the connecting member 130 can move along the parallel portion 244.

Further, the insertion portion 132 rotates through the bar coupling portion 154, the parallel parts 244, and the driving unit 270, which are rotated together by the rotating gear (not shown) when tension is applied to the rotating wire 142, and the force with rotation of the insertion portion 132 rotates the clip 134 through the gear portion.

The receiving portion 138 has an opening 139, with the left side open to the outside, and the anti-separation roller 252 and the roller support 254 are inserted into the receiving portion 138 through the opening 139 and prevent separation of the moving wire 144.

The rolling portions 136 rotatably couples to the left and right ends of the connecting member 130 and allow the connecting member 130 to move while rolling on the top inside the guide rail 220 described above.

Further, a locking protrusion is selectively disposed on the connecting member 130. The locking protrusion 135 holds and prevents all the connecting members 130 from moving, when the connecting members 130 move to the front or rear parallel portion 244, from the state of FIG. 5.

That is, when the connecting members 130 are sequentially moved by the connector 133, the locking protrusion 135 prevents all the connecting members 130 from collecting at the parallel portions 244 by selectively coming in contact with a contact protrusion (reference numeral 255 of FIGS. 5 and 7) of the anti-separation member 250.

The operation of the advertising display device 100 is described hereafter with reference to FIGS. 1 to 9.

First, it is necessary to pull the rotating wire 140 to change a figure or a pattern, with the third display parts 114 exposed to the outside, as shown in FIGS. 1 and 3.

The rotating wire 142 forms a closed loop while being pulled by a user and provides the force to the rotating gear, and the rotary gear receiving the force transmits the force to the bar coupling portion 154, the parallel part 244 and the driving unit 270.

As a result, the slits 110 rotate and, as shown in FIG. 2, the first display parts 112 turn to the front.

On the other hand, in order to turn the second display part 113 and fourth display part 115 to the front, the user pulls the moving wire 144.

That is, as the moving wire 144 is pulled and moves along the same path while forming a closed loop, the tension is transmitted to the coupler 145 and moves along the parallel portion 244 to the left side in FIG. 1.

When the coupler 145 and the connecting members 130 arrive at a curved part 242, the anti-separation roller 252 and a roller support 254 are received in the receiving portion 138, and the rolling portions 136 roundly roll along a receiving groove 253 of the anti-separation member 250.

Thus, the connecting member 130 makes U turn, with the moving wire 144 prevented from separating by the anti-separation member 250, such that it can enter the rear parallel part 244.

Then, when the coupler 145 and the connecting members 130 move onto the parallel portion 144 after passing the curved portion 242, the slits 110 turn such that the first display part 112 on front side, as shown in FIG. 2, is switched with the fourth display part 115.

By such an operation, the first display part 112 to fourth display part 115 can be all shown to the user positioned at the front.

And, when the slits 110 make a U turn by the anti-separation member 250 from the state shown in FIG. 1, the leftmost slit 110 in FIG. 1 is moved to the right end of the rear parallel portion 244 and the rightmost slit 110 in FIG. 1 is stopped by the locking protrusion 135 and the contact protrusion 255 while making a U turn inside the anti-separation member 250.

The scope of the present invention is not limited to the embodiments described above and the present invention may be modified in various ways by those skilled in the art without departing from the scope of the present invention.

For example, the present invention may provide a guide block 300 having guide grooves 310 recessed in forward/backward directions, as shown in FIG. 10, and the lower portions of the slits 110 may be fixed without shaking by disposing wheels 118, which roll along the guide groove 310, at the lower ends of the slits 110.

Also, when an advertising display device is installed outdoors, it is easily apparent that a transparent windshield 400 may be disposed to function as a signpost.

Furthermore, the slit itself can selectively emit by the application of LED panel or LumiSheet, and it is possible to improve visibility without additional lighting devices (a lighting raying light to slit from the slit front).

What is claimed is:

1. An advertising display device, including:
a plurality of slits having separate display parts that display many different kinds of figures or patterns;
a support member supporting the weight of the slits;
a connecting member connecting the slits with the support member; and
an operation unit forcing the slits to rotate and move,
wherein the display parts are separated about a rotation center of each of the slits.

2. The device of claim 1, wherein a guide block with a guide groove recessed straight is disposed under the slits and wheels that roll along the guide groove are disposed at one side of the lower end of each of the slits.

3. The device of claim 1, wherein the slits partially and selectively overlap adjacent slits.

4. The device of claim 3, wherein the display part is provided more than 4 on the outer surface of the slits.

5. An advertising display device, including:
a plurality of slits having separate display parts that display many different kinds of figures or patterns;
a support member supporting the weight of the slits and guiding movement of the slits;
a connecting member connecting the slits with the support member; and
an operation unit forcing the slits to rotate and move,
wherein a turning mechanism turning both sides of the slits by moving the connecting member is provided at a side of the support member.

6. The device of claim 5, wherein the turning mechanism includes a guide rail guiding a moving direction of the connection body and selectively placing the connecting member in a width direction to the front and rear half portions of the support member, and a rotary bar disposed through the connecting member at a side in the guide rail and rotating the slit by selectively rotating.

7. The device of claim 6, wherein the rotary bar has a curved portion formed by bending a portion of the rotary bar, and a pair of parallel portions, except for the curved portion, is parallel to each other

8. The device of claim 7, wherein the curved portion and the parallel portions have different cross-sectional shapes.

9. The device of claim 8, wherein the parallel portions are rotatably constructed and the curved portion has a smaller cross-section than the parallel portions.

10. The device of claim 7, wherein a moving wire disposed through the connecting member and forcing the connecting member to move while circulating into/out of support member by the operation of a user is provided at one side of the operation unit

11. The device of claim 8, wherein an anti-separation member preventing a moving wire in the connecting member, which passes the curved portion, from being separated is provided at position spaced from the rotary bar.

12. The device of claim 11, wherein a receiving groove guiding rolling of the connecting member is recessed to have a curvature corresponding to the curved part is disposed at a side of the anti-separation body.

13. The device of claim 12, wherein an anti-separation protrusion restricting movement in one direction of the moving wire by coming in contact with one side of the connecting member is provided at one side of the anti-separation body.

14. An advertising display device including a plurality of slits to block incident light by a selective rotating, wherein the outer surfaces of the slits each have a display part including:
a first display part disposed on a side of the slit;
a second display part separately disposed on the same surface with the first display part;
a third display part disposed on the other side of the slit; and
a fourth display part separately disposed on the same surface with the third display part.

15. The device of claim 14, wherein the first display part to the fourth display part display different figures or patterns.

16. The device of claim 14, wherein the first display part to the fourth display part have the same width.

17. The device of claim 14, wherein the first display part to the fourth display part are provided in the slits, except for a pair of slits at both ends.
